(19) United States
(12) Patent Application Publication
(10) Pub. No.: US 2024/0248777 A1
(43) Pub. Date: Jul. 25, 2024

(54) METHOD FOR ENABLEMENT OF SERVICE API EXPOSED BY EAS AND A DEVICE PERFORMING THE SAME

(71) Applicant: ELECTRONICS AND TELECOMMUNICATIONS RESEARCH INSTITUTE, Daejeon (KR)

(72) Inventor: Seung-Ik LEE, Daejeon (KR)

(73) Assignee: ELECTRONICS AND TELECOMMUNICATIONS RESEARCH INSTITUTE, Daejeon (KR)

(21) Appl. No.: 18/417,125

(22) Filed: Jan. 19, 2024

(30) Foreign Application Priority Data
Jan. 20, 2023 (KR) 10-2023-0008731
Jan. 17, 2024 (KR) 10-2024-0007377

(51) Int. Cl. G06F 9/54

(52) U.S. Cl. CPC G06F 9/547

(57) ABSTRACT

Provided are a method of enablement of a service application programming interface (API) exposed by an edge application server (EAS) and a device for performing the same. A service API enablement method includes performing, by a first EAS, EAS registration with an edge enabler server (EES), performing, by a second EAS, EAS registration with the EES, transmitting, by the second EAS, a service API publish request to the EES in order to publish a service API of the second EAS, discovering, by the first EAS, a service API in the EES, and invoking, by the first EAS, the service API discovered in the EES and published by a second EAS, wherein the service API publish request may include a service key performance indicator (KPI).

### FIELD OF THE INVENTION

One or more embodiments relate to a method of enablement of service application programming interfaces (APIs) exposed by an edge application server (EAS) and a device for performing the method.

### DESCRIPTION OF THE RELATED ART

Edge computing technology for transmitting data using an edge server is being discussed. Edge computing technology may include multi-access edge computing (MEC) or fog computing (FOC). Edge computing technology may refer to technology that provides data to an electronic device through a separate server (e.g., an edge data network, an MEC server, or a mobile edge host) installed at a location geographically close to the electronic device, for example, in or near a base station. For example, an application requiring low latency among applications installed in an electronic device may transmit/receive data through an edge server installed in a geographically close location, rather than through a server located in an external data network (DN) (e.g., the Internet).

Services using edge computing technology (e.g., MEC-based services or edge computing services) are being discussed, and research and development on electronic devices to support edge computing services are in progress. For example, an application of an electronic device may transmit/receive edge computing-based data on an edge server (or an application of the edge server) and an application layer.

As research and development to support edge computing services progress, a method of efficiently operating MEC system resources while the edge data network (e.g., MEC server) that provides edge computing services satisfies the service latency requirements is being discussed. For example, a method of redeploying edge computing services to terminals in a hierarchical edge data network is being studied.

The background art described above is possessed or acquired by the inventor in the process of deriving the disclosure of the present application, and cannot necessarily be said to be a known technology disclosed to the general public prior to the present application.

### SUMMARY OF INVENTION

### Problem to be Solved

Due to the closed nature of the existing mobile communication network, it is difficult to utilize network information and services for external multi-access edge computing (MEC) applications and interoperate between systems, and as 5G MEC technology is limited to network operator-led use, the spread of 5G+ convergence service industry may be limited. In order to spread the 5G+ convergence service industry, it is necessary to share network resources and services within the 5G network and to support service application programming interfaces (APIs) exposed (or provided) by third-party service providers in the 5G MEC platform.

Various embodiments may support registration, search, and invocation for service APIs exposed by an edge application server (EAS) in the 5G platform.

Various embodiments enable network operators to provide a service platform by allowing service APIs provided by third-party service providers to be utilized at the network edge, and may localize service invocation traffic to the network edge.

However, technical objects are not limited to the above-described technical objects, and other technical objects may exist.

### Solution to Problem

According to an aspect, there is provided a service API enablement method including performing, by a first EAS, EAS registration with an edge enabler server (EES), performing, by a second EAS, EAS registration with the EES, transmitting, by the second EAS, a service API publish request to the EES in order to publish a service API of the second EAS, discovering, by the first EAS, a service API in the EES, and invoking, by the first EAS, the service API discovered in the EES and published by a second EAS, wherein the service API publish request comprises a service key performance indicator (KPI).

The service KPI may include one or more information elements.

The one or more information elements may include one or more of a maximum request rate, maximum response time, availability, available compute, available graphical compute, available memory, available storage, and connection bandwidth.

The second EAS may be an EAS owned by a third party or a public land mobile network (PLMN) operator.

The service API enablement method may further include registering, by the second EAS, an API provider domain function thereof with the EES.

The service API enablement method may further include subscribing, by the first EAS, to an update notification of a target service API in the EES.

The target service API may be a service API provided by the second EAS.

The EES may provide a common API framework (CAPIF) function in a distributed or centralized manner or a combination of thereof.

The service API enablement method may further include performing, by the EES, interconnection for publishing and discovering of a service API managed by the EES to a different EES.

According to another aspect, there is provided a service API enablement method including performing, by an EAS, an onboarding process with an EES, registering, by a second EAS, an API provider domain function thereof with the EES, transmitting, by the second EAS, a service API publish request to the EES in order to publish a service API of the second EAS, discovering, by the first EAS, a service API in the EES, and invoking, by the first EAS, the service API published by the second EAS and discovered in the EES, wherein the service API publish request comprises a service KPI.

The service KPI may include one or more information elements.

The one or more information elements may include one or more of a maximum request rate, maximum response time, availability, available compute, available graphical compute, available memory, available storage, and connection bandwidth.

The second EAS is an EAS owned by a third party or a PLMN operator.

The service API enablement method may further include subscribing, by the first EAS, to an update notification of a target service API in the EES.

The target service API may be a service API provided by the second EAS.

The EES may provide a CAPIF function in a distributed or centralized manner or a combination thereof.

The service API enablement method may further include performing, by the EES, interconnection for publishing and discovering of a service API managed by the EES to a different EES.

According to another aspect, there is provided a service API enablement method including performing, by an EES, an onboarding process with an EAS, registering, by the EES, an API provider domain function of a second EAS, receiving, by the EES, a service API publish request from the second EAS in order to publish a service API of the second EAS, and receiving, by the EES, a service API discover request of the first EAS, wherein the service API publish request comprises a service KPI, wherein a service API published by the second EAS and discovered in the EES according to the service API discover request of the first EAS is invoked to the first EAS.

The service KPI may include one or more information elements.

The one or more information elements may include one or more of a maximum request rate, maximum response time, availability, available compute, available graphical compute, available memory, available storage, and connection bandwidth.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram schematically illustrating a network environment for supporting an edge computing service according to various embodiments;

FIGS. 2A and 2B are diagrams illustrating examples of a network environment for an edge application server (EAS) service application programming interface (API) enablement using a common API framework (CAPIF), and FIG. 2C is a diagram illustrating a function exposure for edge application enablement;

FIG. 3 is a flowchart illustrating a method for EAS service API enablement using CAPIF according to various embodiments; and

FIG. 4 is a schematic block diagram illustrating a device according to various embodiments.

### DETAILED DESCRIPTION

The following structural or functional descriptions of embodiments described herein are merely intended for the purpose of describing the embodiments described herein and may be implemented in various forms. However, it should be understood that these embodiments are not construed as limited to the illustrated forms. Various modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

As used herein, the singular forms “a,” “an,” and “the” are intended to include the plural forms as well, unless the context clearly indicates otherwise. As used herein, phrases such as “A or B”, “at least one of A and B”, “at least one of A or B”, “A, B or C”, “at least one of A, B and C”, and “A, B, or C,” may include any one of the items listed together in the corresponding one of the phrases, or all possible combinations thereof. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

As used herein, the term ‘unit’ refers to software or a hardware component such as a field programmable gate array (FPGA) or an application-specific integrated circuit (ASIC), and ‘unit’ performs certain roles. However, ‘unit’ is not meant to be limited to software or hardware. The ‘unit’ may be configured to reside on an addressable storage medium or may be configured to regenerate one or more processors. For example, ‘unit’ may include components such as software components, object-oriented software components, class components, and task components, processes, functions, properties, procedures, subroutines, segments of program code, drivers, firmware, microcode, circuitry, data, databases, data structures, tables, arrays, and variables. Functions provided within components and ‘units’ may be combined into a smaller number of components and ‘units’ or further divided into additional components and ‘units’. In addition, components and ‘units’ may be implemented to execute one or more CPUs in a device or secure multimedia card. Furthermore, ‘unit’ may include one or more processors.

Hereinafter, embodiments will be described in detail with reference to the accompanying drawings. In the description with reference to the accompanying drawings, the same components are assigned the same reference numerals regardless of the reference numerals, and the overlapping description thereof will be omitted.

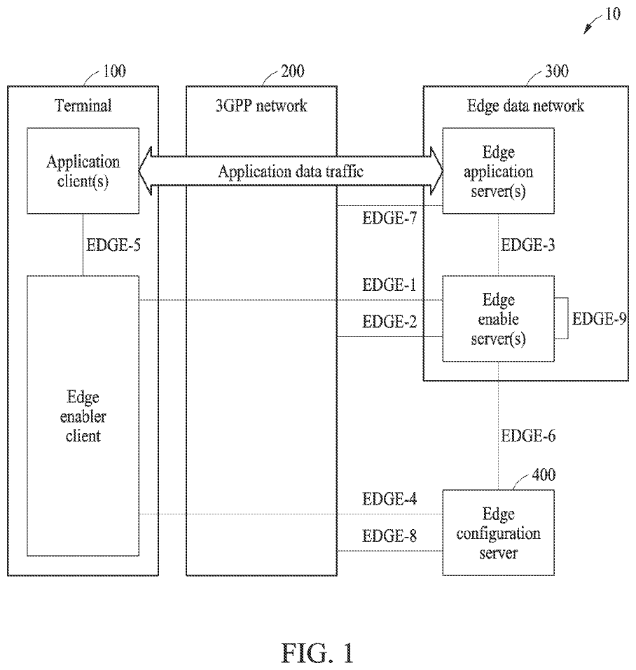

FIG. 1 is a diagram schematically illustrating a network environment for supporting an edge computing service according to various embodiments.

Referring to FIG. 1, a network environment 10 (e.g., 3GPP 5G MEC platform (EDGEAPP)) may include a terminal 100, a 3^{rd} generation partnership project (3GPP) network (e.g., 3GPP core network) 200, an edge data network 300, and an edge configuration server (ECS) (e.g., edge data network configuration server) 400. The network environment 10 may not be limited to the components (i.e., 100˜400) illustrated in FIG. 1.

Each component included in the network environment 10 may refer to a physical entity unit or a software or module unit that performs an individual function. A component included in the network environment 10 may be referred to as an entity or a function.

The terminal 100 may refer to a device used by a user. For example, the terminal 100 may refer to user equipment (UE), a remote terminal, a wireless terminal, or a user device. The terminal 100 may include all types of electronic devices.

The terminal 100 may include one or more application clients (AC), and edge enabler clients (EEC). The terminal 100 may further include a 3GPP communication layer (not shown). The AC may also be referred to as a UE application (UE App) or a client application. An EEC 120 may also be referred to as an MEC enabling layer (MEL).

The terminal 100 may execute (or drive) one or more ACs. The AC may require different network services (e.g., enhanced mobile broadband (eMBB), ultra-reliable and low latency communication (URLLC), or massive machine type communication (mMTC)). The AC may require different network services based on one or more of a data transmission rate, latency (or rate), reliability of the terminal 100, the number of terminals 100 accessing the network, the network access period of the terminal 100, and average data usage.

The AC may refer to a basic application pre-installed in the terminal 100 or an application provided by a third party. The AC may refer to a client application program driven in the terminal 100 for a specific application service. Several ACs may be driven in the terminal 100. One or more of the ACs may be used to provide an edge computing service from the edge data network 300 to the terminal 100. The AC may exchange service data through interaction with an edge application server (EAS) as the client side of an MEC application. For example, the AC is an application installed and executed in the terminal 100 and may provide a function of transmitting/receiving data through the edge data network 300. The AC may refer to application software (or module) executed on the terminal 100 to use a function provided by one or more specific EASs (e.g., edge application).

The EEC may refer to a layer that performs an operation within the terminal 100 that enables the terminal 100 to use an edge computing service. The EEC may determine which AC (e.g., UE App) may use the edge computing service and perform an operation of connecting the network interface so that the data of the AC of the terminal 100 may be provided to the edge data network 300 that provides the edge computing service. The EEC may search for and discover an EAS.

In addition, the EEC may perform an operation for the terminal 100 to establish a data connection for using the edge computing service with the 3GPP communication layer. The 3GPP communication layer may refer to a layer that performs a modem operation for using a mobile communication system. The 3GPP communication layer may establish a wireless connection for data communication, register the terminal 100 in the mobile communication system, establish a connection for data transmission in the mobile communication system, and transmit/receive data.

The 3GPP network 200 is a wireless communication system conforming to the standard of the 3GPP and may be connected to the terminal 100 to provide a wireless communication service to the terminal 100. The 3GPP network 200 may include, but is not limited to, a 3rd generation (3G) network, a long term evolution (LTE) network, an LTE-A network, and a next-generation network (e.g., 5G or New Radio (NR)). The 3GPP network 200 may include networks configured with other communication technologies.

The 3GPP network 200 may include a radio access network (RAN) (not shown) and a core network (not shown). The RAN is a network directly connected to the terminal 100 and may be an infrastructure that provides wireless access to the terminal 100. The RAN may include a plurality of base stations, and the plurality of base stations may perform communication through an interface formed between the plurality of base stations. At least some of the interfaces between the plurality of base stations may be wired or wireless. A base station may be referred to as a gNode B, an eNode B, a Node B, a base station (BS), a radio access unit, a base station controller, a node on a network, or other terms having an equivalent technical meaning. The core network may process data and control signals for the terminal 100 transmitted/received through the RAN. The core network may perform various functions such as control of user plane and control plane, mobility processing, management of subscriber information, billing, and interworking with other types of systems (e.g., LTE systems). In order to perform the various functions described above, the core network may include a plurality of functionally separated entities having different network functions (NFs). For example, the core network may include one or more of a user plane function (UPF), an access and mobility management function (AMF), a session management function (SMF), a policy control function (PCF), a network exposure function (NEF), and user data management (UDM), a network data analysis function (NWDAF), or a gateway mobile location center (GMLC), or any combination thereof.

The UPF may provide a data path (or data plane) between the terminal 100 and the edge data network 300. The UPF may serve as a gateway for delivering data (or data packets) transmitted/received by the terminal.

The terminal 100 and the edge data network 300 may transmit/receive data (or data packets) therebetween through the UPF. A data network may exist between the edge data network 300 and the UPF.

The UPF may be located close to the edge data network 300 to support the edge computing service to the terminal 100 and may deliver the data packet of the terminal 100 to the edge data network 300 with low latency, or deliver the data packet of the edge data network 300 to the terminal 100 with low latency.

The UPF may provide a data path between the terminal 100 and the edge data network 300 using a data network connected to the Internet. The UPF may route data packets to be delivered to the Internet among data packets transmitted by the terminal 100 to a data network between the service server 400 and the terminal 100.

The NEF may be an NF that exposes capabilities and services of the NFs of the 3GPP network 200 to the outside. The NEF may be connected to an external server (e.g., the edge data network 300) to perform a capability of delivering information about an event occurring in the NF inside the 3GPP network 200 to the external server, or delivering information about an event requested by the external server to the internal NF. For example, the capabilities and services exposed by the NEF to the outside may be location-related event reporting of the terminal 100, session-related event reporting of the terminal 100, mobility management event reporting of the terminal 100, and the like. The external server may access the corresponding capabilities and services by subscribing the capabilities and services exposed by the NEF.

The edge data network 300 may refer to a server to which the terminal 100 connects to use an edge computing service. The edge data network 300 may be disposed within the BS of the 3GPP network 200 to which the terminal 100 is connected or in a location geographically close to the BS. The edge data network 300 may be referred to as an MEC server, an MEC host, an edge computing server, a mobile edge host, an edge computing platform, and the like.

The edge data network 300 may include one or more EASs and one or more EESs.

The edge data network 300 may execute (or drive) one or more EASs. The EAS may be referred to as an edge application, an MEC application, or an ME (MEC) App. The EAS may refer to an application (or application server) provided by a third party (e.g., a service provider) in the edge data network 300 that provides edge computing services. The EAS may be used to establish a data session with the AC in order to transmit/receive data related to the AC. The EAS may establish a data session with the AC. The data session may refer to a communication path formed to transmit/receive data between the AC and the EAS of the terminal 100.

The edge data network 300 may provide a virtual resource to an edge application (e.g., EAS). For example, the virtual resource may include one or more of a computing resource, a storage resource, and a network resource (e.g., network bandwidth) that the EAS may use. The EAS may be executed (or driven) as a virtual machine.

The EES may be referred to as a mobile edge computing (MEC) platform, a mobile edge platform (MEP), or a platform.

The EES may provide functions required for the execution of the EAS. For example, the EES may provide a function or environment so that the EAS may provide the edge computing service to the terminal 100 or the EAS may consume the edge computing service. In addition, the EES may perform traffic control or domain name system (DNS) handling.

Edge computing service may collectively refer to services related to procedures and information required to use edge applications (e.g., EAS). The edge computing service may be provided or consumed by the EES and/or the EAS. For example, the EAS may provide an edge computing service to the terminal 100 or may use an edge computing service provided by the EES to provide an edge computing service to the terminal 100. In addition, the EES may provide the EAS with an edge computing service that the EAS may use to provide the edge computing service to the terminal 100. In other words, the edge computing service may refer to a service provided by the edge data network 300 or the EAS to the terminal 100 or a service provided by the EES and available to the EAS.

The EES may provide edge computing services to the EAS. For example, the EES may provide various types of information (e.g., data, content, information about the location of a terminal, caching data, information about a service to be subscribed, etc.) to the EAS according to the edge computing service provided. The EAS may provide the edge computing service to the terminal 100 by using the edge computing service provided by the EES. For example, the EAS may provide an edge computing service to the terminal 100 based on information provided by the EES as an edge computing service. The edge computing service provided to the terminal 100 may be a service required by the terminal 100 to drive an AC (e.g., provide data required to drive the AC).

The EES may include an MEC service (not shown) and a service registry (not shown). The MEC service may provide an edge computing service to EASs included in the edge data network 300. The MEC service may be implemented as software or a module that may perform individual functions. The service registry may provide information on edge computing services available in the edge data network 300.

The EES may internally register the EAS when an instance of the EAS is instantiated. The EES may register the EAS and store information related to the EAS. The EAS-related information stored by the EES may include information on the edge computing service that the EAS intends to provide to the terminal 100 and the like, and information on whether the edge computing service is a required service or an optional service for the EAS.

The EAS may register a new edge computing service with the EES, update an edge computing service already registered, or search for an edge computing service registered with the EES. The EAS may provide the EES with information on the edge computing service to be registered or updated while registering or updating the edge computing service in the EES. The EES may register edge computing services with a service registry.

The EES may deliver information about edge computing services registered in the service registry to the EAS in the edge data network 300. For example, the EES may deliver a list of edge computing services registered in the service registry to the EAS. In addition, the EES may deliver information on availability of edge computing services registered in the service registry or newly registered to the EAS.

The EAS may subscribe to the edge computing service registered in the service registry. The EAS may subscribe to the edge computing service by delivering subscription request information for the edge computing service to the EES. When the EAS subscribes to the edge computing service, it may mean that the edge computing service or information on the edge computing service is continuously provided from the EES.

The ECS may provide support functions for the terminal 100 to connect with the EES. The ECS 400 may be referred to as an edge data network management server, a configuration server, etc., and may perform the function of a mobile edge platform manager (MEPM) or a multi-access edge orchestrator (MEO). The ECS 400 may refer to an MEC management proxy (MMP) server or a DNS server.

The ECS 400 may refer to an initial access server through which the terminal 100 may receive edge data network configuration information for using an edge computer service. The ECS 400 may know the deployment of edge data networks, and the terminal 100 may access the ECS 400 and receive configuration information required for using an edge computing service, for example, information on an edge data network to be accessed at a specific location.

The ECS 400 may perform a function of provisioning edge data network configuration information to the EEC of the terminal 100. For example, the edge data network configuration information may include information for the terminal 100 to connect to the edge data network 300 using the service area information (e.g., information on edge data networks that provide services in a certain area, etc.) and information for establishing a connection with the EES 330 (e.g. information to identify edge data networks, etc.).

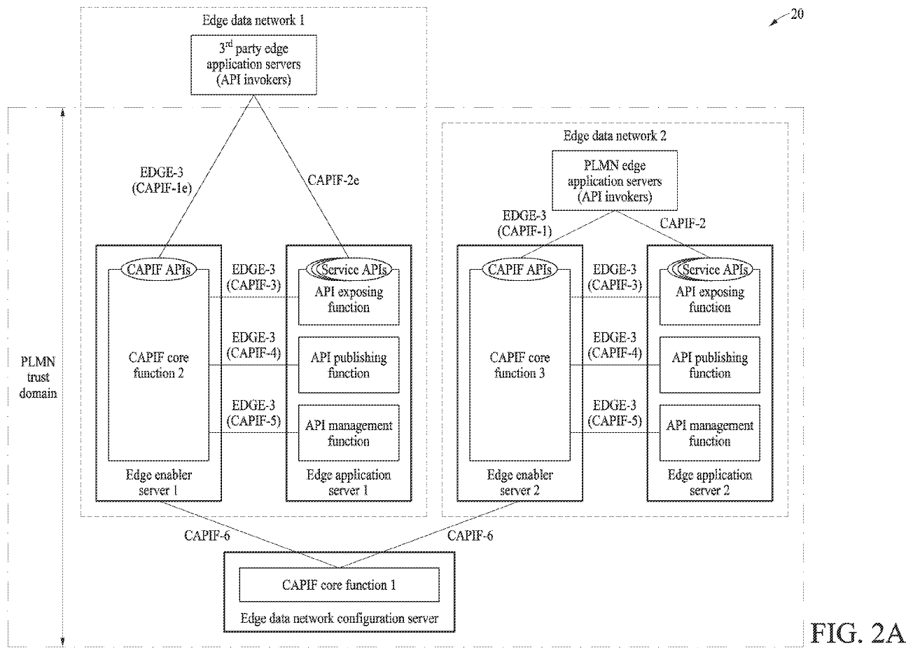

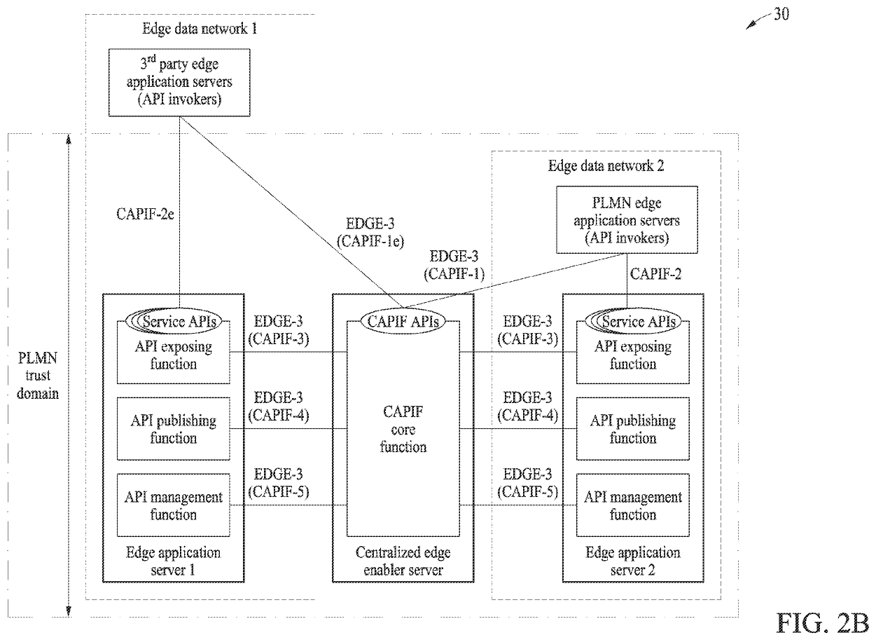

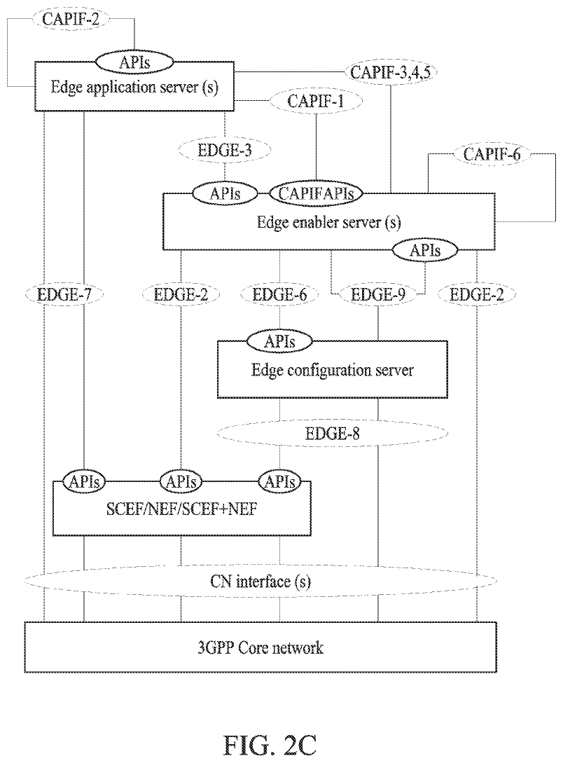

FIGS. 2A and 2B are diagrams illustrating examples of a network environment for EAS service application programming interface (API) enablement using a common API framework (CAPIF), and FIG. 2C is a diagram illustrating a function exposure for edge application enablement.

Referring to FIGS. 2A to 2C, according to various embodiments, network environments 20 and 30 (e.g., the network environment 10 of FIG. 1) may support the EAS to expose a service API thereof (e.g., the service API of the EAS) to other EASs. Various embodiments may provide an EAS service API enablement method using a CAPIF (for example, see 3GPP TS 23.222).

A list of service APIs exposed in the network environments 20 and 30 may be shown in Table 1.

TABLE 1

Service APIs exposed by EES
UE location API
ACR management event API
AC information exposure API
UE Identifier API
Session with QOS API
Service APIs exposed by 5GC (i.e., 5GC Service APIs)
Service APIs provided by SCEF/NEF/SCEF +
NEF/PCF (or directly by 5GC in a trusted case)
Service APIs exposed by EASs (i.e., EAS Service APIs)
Service APIs provided by application service providers

An edge enabler layer (e.g., EES) may expose service APIs to an EAS. The exposed service API may include the capability provided by the EES (e.g., see Section 8.6 of TS 23.558), the capability provided by the 3GPP core network (e.g., see Section 8.7 of TS 23.558), and the SEAL service API (e.g., see Section A.4 of TS 23.558).

In the EAS service API enablement method, the edge enabler layer (e.g., EES) may support the EAS to expose its own service API (e.g., EAS service API) to other EASs. The EAS service API enablement method may support publication/discovery and change subscription of the EAS service API within the CAPIF architecture by utilizing CAPIF.

The EES may provide the CAPIF function in a distributed manner as shown in FIG. 2A, or may provide the CAPIF function in a centralized manner as shown in FIG. 2B. The EES may provide the CAPIF function in a distributed or centralized manner, or a combination of the two, to support edge applications (e.g., edge applications owned by third parties or PLMN operators) access to service APIs provided by other EASs within and across edge data networks.

In each of the network environments 20 and 30, in order to support the EAS to expose its own service API (e.g., service API of EAS) to other EASs, roles of the EAS and EES may be defined as follows.
(1) The EAS may use (or implement) one or more of the API provider domain functions (e.g., API exposing function, API publishing function, or API management function), or any combination thereof to act as an API provider.
(2) The EAS may also act as an API invoker.
(3) The EES may act as a CAPIF provider using (or implementing) a CAPIF core function (CCF).

Based on the above-described role, the EAS service API enablement method may include the following operations of the EAS and EES.
(1) The EAS acting as an API provider may publish the EAS service API (e.g., EAS own service API) to the EES.
(2) The EAS acting as an API invoker may discover the EAS service API in the EES.
(3) The EAS acting as an API invoker may subscribe to receive notifications from the EES about one or more of the dynamic information or availability of the EAS service API, or a combination of two or more thereof.

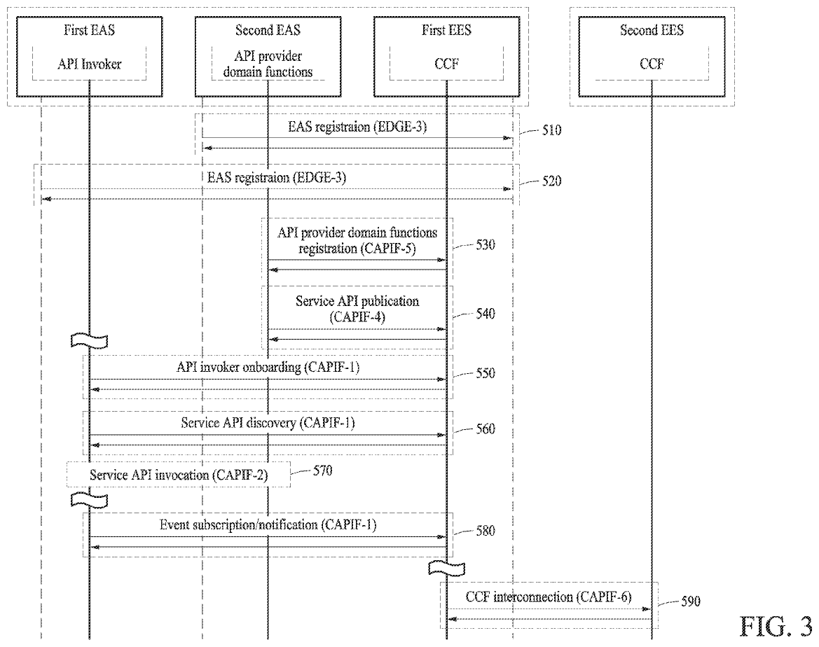

FIG. 3 is a flowchart illustrating a method for EAS service API enablement using CAPIF according to various embodiments.

In FIG. 3, for convenience of explanation, it is assumed that the first EAS (e.g., a 3^{rd} party edge application server or PLMN edge application server in FIG. 2A and a 3^{rd} party edge application server or PLMN edge application server in FIG. 2B) serves as an API invoker, and the second EAS (e.g., Edge application server 1 or Edge application server 2 of FIG. 2A and Edge application server 1 or Edge application server 2 of FIG. 2B) serves as an API provider. The first EAS and the second EAS may be disposed in the same edge data network or may be disposed in different edge data networks.

In operation 510, the second EAS may perform EAS registration with the first EES (Edge enabler server 1 or Edge enabler server 2 of FIG. 2A and Centralized Edge Enabler Server of FIG. 2B).

In operation 520, the first EAS may perform EAS registration with the first EES (Edge enabler server 1 or Edge enabler server 2 of FIG. 2A and Centralized Edge Enabler Server of FIG. 2B).

In operation 530, the second EAS (e.g., AMF) may register the API provider domain function thereof with the first EES (e.g., CCF) through CAPIF-5.

In operation 540, the second EAS (e.g., APF) may publish the exposed service API thereof to the first EES (e.g., CCF) through CAPIF-4. The second EAS (e.g., APF) may transmit a service API publish request to the first EES (e.g., CCF). For example, the service API publish request may be defined through Table 2 and Table 3.

In operation 550, the first EAS (e.g., API invoker) may perform an onboarding process with the first EES (e.g., CCF) through CAPIF-1.

In operation 560, the first EAS (e.g., API invoker) may discover a service API (e.g., a service API required to execute) from the EES (e.g., CCF) through CAPIF-1.

In operation 570, the first EAS (e.g., API invoker) may invoke a service API provided by the second EAS (e.g., AEF) discovered in the first EES (e.g., CCF) through CAPIF-2.

In operation 580, the first EAS (e.g., API invoker) may subscribe to the update notification of the target service API (e.g., the service API provided by the second EAS) on the first EES (e.g., CCF) through CAPIF-1.

In operation 590, the first EES (e.g., CCF) and the second EES (CCF) may interoperate with each other through CAPIF-6 for an interconnection operation for publication and discovery of a service API managed by each EES.

In the above-described EAS service API enablement method including operations 510 to 590, a service key performance indicator (KPI) in the CAPIF for the EAS service API may be used. The “service KPI” IE may be designated to provide information on the service characteristic provided by the EAS or may be required by the AC. The “service KPI” IE may be used for discovering or provisioning of an EAS that meets the service KPIs required by the AC.

Service KPIs from the EAS (e.g., API provider) may be designated in CAPIF for use in discovering or provisioning of EAS service APIs that meet service KPIs required by the EAS (e.g., API invoker).

The IE proposed by CAPIF related to the service KPI may be summarized as follows.

### 1) Service KPIs Provided by the EAS as an API Provider

a. Service API Publish Request (for Example, See TS 23.222)

A service API publish request may include one or more information elements. An information element may include one or more of API publisher information, service API information, and shareable information.

TABLE 2
Service API publish request

| Information | | |
|---|---|---|
| element | Status | Description |
| API publisher | M | The information of the API publisher may |
| information | | include identity, authentication and |
| | | authorization information. |
| Service API | M | The service API information includes the |
| information | | service API name, service API type, |
| | | communication type, description, serving area |
| | | information (optional), AEF location |
| | | (optional), interface details (e.g. IP address, |
| | | port number, and uniform resource identifier |
| | | (URI)), protocols, version numbers, and data |
| | | format, (new) service KPI. |
| Shareable | O | Indicates whether the service API or the |
| information | (see | service API category can be published to other |
| | NOTE) | CCFs. And if sharing, a list of CAPIF provider |
| | | domain information where the service API or |
| | | the service API category can be published is |
| | | contained. |

NOTE:
If the shareable information is not present, the service API is not allowed to be shared.

i. Service API information

Service API information may include a service API name, API provider name, list of public IP ranges of UE, service API type, service API status (e.g., active or inactive), communication type, description, serving area information, AEF information, interface details (e.g., an IP address, a port number, and URI), protocols, version number, data format, and service KPIs.
Service KPI (new IE): Information about the service characteristic provided by the service API, the service KPI may be mapped to the EAS service KPI in the EAS profile (for example, see TS 23.558) of the EAS that provides the service API.

Here, the service KPI may include information about a performance indicator requested by the API invoker and/or a performance indicator that the service API may provide. The service KPI may include one or more information elements. An information element may include one or more of a maximum request rate, maximum response time, availability, available compute, available graphical compute, available memory, and available storage, and connection bandwidth. The service KPI may be defined as shown in Table 3.

TABLE 3
Service KPIs

| Information | | |
|---|---|---|
| element | Status | Description |
| Maximum | O | Maximum request rate from the API invoker |
| Request rate | | supported by the server. |
| Maximum | O | The maximum response time advertised for the |
| Response time | | API invoker's service requests. |
| Availability | O | Advertised percentage of time the server is |
| | | available for the API invoker's use. |
| Available | O | The maximum compute resource available for |
| Compute | | the API invoker. |
| Available | O | The maximum graphical compute resource |
| Graphical | | available for the API invoker. |
| Compute | | |
| Available | O | The maximum memory resource available for |
| Memory | | the API invoker. |
| Available | O | The maximum storage resource available for |
| Storage | | the API invoker. |
| Connection | O | The connection bandwidth in kilobit (kbit)/s |
| Bandwidth | | advertised for the API invoker's use. |

### 2) Service KPIs Required by the EAS as an API Invoker

a. Onboard API Invoker Response (for Example, See TS 23.222)

### i Service API Information

Service KPI by API (new IE): Information on service characteristics provided by the service API to which access is allowed

TABLE 4
Onboard API invoker response

| Information | | |
|---|---|---|
| element | Status | Description |
| Onboarding | M | The result of onboarding request, i.e., success |
| status | | indication is included if the API invoker is |
| | | granted permission otherwise failure. |
| Enrolled | O | Information from the provisioned API invoker |
| information | (see | profile which may include information to allow |
| | NOTE 1) | the API invoker to be authenticated and to |
| | | obtain authorization for service APIs |
| Service API | O | The service API information includes the |
| information | (see | service API name, service API type, |
| | NOTE 2) | communication type, description, Serving Area |
| | | Information (optional), AEF location (optional), |
| | | interface details (e.g. IP address, port number, |
| | | and URI), protocols, version numbers, and data |
| | | format, (new) Service KPI. |
| Reason | O | This element indicates the reason when |
| | (see | onboarding status is failure. |
| | NOTE 3) | |

NOTE 1:
Information element shall be present when onboarding status is successful.
NOTE 2:
Information element may be present when onboarding status is successful.
NOTE 3:
Information element shall be present when onboarding status is failure.

b. Service API Discover Request (for Example, See TS 23.222)
i Query information
Service KPI (new IE): Information on service characteristics as a criterion for discovering the matching service API required by the API invoker

TABLE 5
Service API discover request

| Information | | |
|---|---|---|
| element | Status | Description |
| API invoker | M | Identity information of the API invoker |
| identity | | discovering service APIs |
| information | | |
| Query | M | Criteria for discovering matching service APIs |
| information | | (e.g. service API type, Serving Area |
| | | Information (optional), preferred AEF location |
| | | (optional), interfaces, protocols, (new) Service |
| | | KPI) |
| | | (see NOTE) |

NOTE:
It should be possible to discover all the service APIs.

c. Service API Discover Response (for Example, See TS 23.222)

### i Service API Information

Service KPI by API (new IE): Information on service characteristics provided by the service API corresponding to the discover request

TABLE 6
Service API discover response

| Information | | |
|---|---|---|
| element | Status | Description |
| Result | M | Indicates the success or failure of the |
| | | discovery of the service API information |
| Service API | O | List of service APIs corresponding to the |
| information | (see ) | request, including API description such as |
| (see NOTE | NOTE 1) | service API name, service API type, serving |
| 2) | | area information (optional), interface details |
| | | (e.g. IP address, port number, and URI), |
| | | protocols, version, data format, (new) |
| | | Service KPI |
| CCF identity | O | Indicates the CCF serving the service API |
| information | (see | category provided in the query criteria |
| | NOTE 1) | |

NOTE 1:
The service API information or the CCF identity information or both shall be present if the Result information element indicates that the service API discover operation is successful. Otherwise both shall not be present.
NOTE 2:
If topology hiding is enabled for the service API, the interface details shall be the interface details of AEF acting as service communication entry point for the service API.

### 3) Service KPI for CAPIF Interconnection Between EESs

a. Interconnection API Publish Request (for Example, See TS 23.222)
i. Service API Information
Service KPI (new IE): Information on service characteristics provided by the service API published in CCF (e.g., those implemented in EES)

TABLE 7
Interconnection API publish request

| Information | | |
|---|---|---|
| element | Status | Description |
| CCF | M | The information of the CCF which publishes |
| information | | APIs, may include identity, authentication |
| | | and authorization information |
| Service | O | The service API information includes the |
| API | (see | service API name, service API type, |
| information | NOTE | communication type, description, Serving |
| | 1) | Area Information (optional), AEF location |
| | | (optional), interface details (e.g. IP address, |
| | | port number, and URI), protocols, version |
| | | numbers, and data format, (new) Service |
| | | KPI. |
| Service | O | The category of the service APIs to be |
| API | (see | published, (e.g., V2X, IoT) |
| category | NOTE | |
| | 1) | |
| Shareable | O | Indicates whether the service API or the |
| information | (see | service API category can be published to |
| | NOTE | other CCFs. In addition, if sharing, a list of |
| | 2) | CAPIF provider domain information where |
| | | the service API or the service API category |
| | | can be published is contained. |

NOTE 1:
At least one of the Service API information or Service API category shall be present.
NOTE 2:
If the shareable information is not present, the service API is not allowed to beshared. There is one and only one CAPIF provider domain information shareable via the CAPIF-6e interface.

b. Interconnection Service API Discover Request (for Example, See TS 23.222)

### i Query Information

Service KPI (new IE): Information on service characteristics as a criterion for discovering the matching service API in CCF (e.g., those implemented in EES)

TABLE 8
Interconnection service API discover request

| Information | | |
|---|---|---|
| element | Status | Description |
| CCF identity | M | Identity information of the CCF discovering |
| information | | service APIs |
| Query | M | Criteria for discovering matching service APIs or |
| information | | CCF (e.g. service API type, Serving Area |
| | | Information (optional), preferred AEF location |
| | | (optional), interfaces, protocols, service API |
| | | category, (new) Service KPI) |
| | | (see NOTE) |

NOTE:
It should be possible to discover all the service APIs.

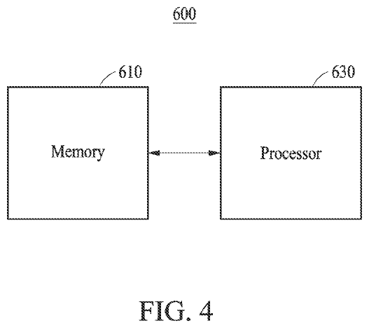

FIG. 4 is a schematic block diagram illustrating a device according to various embodiments.

Referring to FIG. 4, according to various embodiments, a device 600 (e.g., a server device) may be substantially the same as the EAS and/or EES described with reference to FIGS. 1 to 3. The device 600 may include a memory 610 and a processor 630.

According to various embodiments, the memory 610 may store instructions (e.g., a program) executable by the processor 630. For example, the instructions may include instructions for executing an operation of the processor 630 and/or an operation of each component of the processor 630.

According to various embodiments, the memory 610 may be implemented as a volatile memory device or a non-volatile memory device. Volatile memory devices may be implemented as dynamic random access memory (DRAM), static random access memory (SRAM), thyristor RAM (T-RAM), zero capacitor RAM (Z-RAM), or twin transistor RAM (TTRAM). Non-volatile memory devices may be implemented as Electrically Erasable Programmable Read-Only Memory (EEPROM), flash memory, Magnetic RAM (MRAM), Spin-Transfer Torque (STT)-MRAM, and Conductive Bridging RAM (CBRAM), Ferroelectric RAM (FeRAM), Phase change RAM (PRAM), Resistive RAM (RRAM), Nanotube RRAM, Polymer RAM (PoRAM), Nano Floating Gate Memory Memory (NFGM)), holographic memory, a molecular electronic memory device, and/or insulator resistance change memory.

According to various embodiments, the processor 630 may execute computer-readable code (e.g., software) stored in the memory 610 and instructions induced by the processor 630. The processor 630 may be a hardware-implemented data processing device having a circuit having a physical structure for executing desired operations. The desired operations may include, for example, code or instructions in a program. The hardware-implemented data processing device may include, for example, a microprocessor, a central processing unit, a processor core, a multi-core processor, a multiprocessor, an ASIC, and an FPGA.

According to various embodiments, the operation performed by the processor 630 is substantially the same as the operation of the EAS and/or EES described with reference to FIGS. 1 to 3. Accordingly, detailed description will be omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit, a DSP, a microcomputer, an FPGA, a programmable logic unit, a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The method according to the embodiments described above may be recorded in non-transitory computer-readable media including program instructions to implement various operations which may be performed by a computer. The media may also include, alone or in combination with the program instructions, data files, data structures, and the like. The program instructions recorded on the media may be those specifically designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specifically configured to store and perform program instructions, such as read-only memory (ROM), random access memory (RAM), flash memory, and the like. Examples of program instructions include both machine code, such as code produced by a compiler, and files containing higher level code that may be executed by a computer using an interpreter.

The described hardware devices may be configured to function as one or more software modules in order to perform the operations of the embodiments described above, or vice versa.

While this disclosure includes embodiments, it will be apparent to one of ordinary skill in the art that various changes in form and details may be made in these embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A service application programming interface (API) enablement method comprising:
performing, by a first edge application server (EAS), EAS registration with an edge enabler server (EES);
performing, by a second EAS, EAS registration with the EES;
transmitting, by the second EAS, a service API publish request to the EES in order to publish a service API of the second EAS;
discovering, by the first EAS, a service API in the EES; and
invoking, by the first EAS, the service API discovered in the EES and published by a second EAS,
wherein the service API publish request comprises a service key performance indicator (KPI).

2. The service API enablement method of claim 1, wherein
the service KPI comprises one or more information elements.

3. The service API enablement method of claim 2, wherein
the one or more information elements comprise one or more of a maximum request rate, maximum response time, availability, available compute, available graphical compute available memory, available storage, and connection bandwidth.

4. The service API enablement method of claim 1, wherein
the second EAS is an EAS owned by a third party or a public land mobile network (PLMN) operator.

5. The service API enablement method of claim 1, further comprising:
registering, by the second EAS, an API provider domain function thereof with the EES.

6. The service API enablement method of claim 1, further comprising:
subscribing, by the first EAS, to an update notification of a target service API in the EES.

7. The service API enablement method of claim 6, wherein
the target service API is a service API provided by the second EAS.

8. The service API enablement method of claim 1, wherein
the EES provides a common API framework (CAPIF) function in a distributed or centralized manner or a combination of thereof.

9. The service API enablement method of claim 1, further comprising:
performing, by the EES, interconnection for publishing and discovering of a service API managed by the EES to a different EES.

10. A service application programming interface (API) enablement method comprising:
performing, by a first edge application server (EAS), an onboarding process with an edge enabler server (EES);
registering, by a second EAS, an API provider domain function thereof with the EES;
transmitting, by the second EAS, a service API publish request to the EES in order to publish a service API of the second EAS;
discovering, by the first EAS, a service API in the EES; and
invoking, by the first EAS, the service API published by the second EAS and discovered in the EES,
wherein the service API publish request comprises a service key performance indicator (KPI).

11. The service API enablement method of claim 10, wherein
the service KPI comprises one or more information elements.

12. The service API enablement method of claim 11, wherein
the one or more information elements comprise one or more of a maximum request rate, maximum response time, availability, available compute, available graphical compute, available memory, available storage, and connection bandwidth.

13. The service API enablement method of claim 10, wherein
the second EAS is an EAS owned by a third party or a public land mobile network (PLMN) operator.

14. The service API enablement method of claim 10, further comprising:
subscribing, by the first EAS, to an update notification of a target service API in the EES.

15. The service API enablement method of claim 14, wherein
the target service API is a service API provided by the second EAS.

16. The service API enablement method of claim 10, wherein
the EES provides a common API framework (CAPIF) function in a distributed or centralized manner or a combination thereof.

17. The service API enablement method of claim 10, further comprising:
performing, by the EES, interconnection for publishing and discovering of a service API managed by the EES to a different EES.

18. A service API enablement method comprising:
performing, by an edge enable server (EES), an onboarding process with a first edge application server (EAS);
registering, by the EES, an API provider domain function of a second EAS;
receiving, by the EES, a service API publish request from the second EAS in order to publish a service API of the second EAS; and
receiving, by the EES, a service API discover request of the first EAS,
wherein the service API publish request comprises a service key performance indicator (KPI),
wherein a service API published by the second EAS and discovered in the EES according to the service API discover request of the first EAS is invoked to the first EAS.

19. The service API enablement method of claim 18, wherein
the service KPI comprises one or more information elements.

20. The service API enablement method of claim 19, wherein
the one or more information elements comprise one or more of a maximum request rate, maximum response time, availability, available compute, available graphical compute, available memory, available storage, and connection bandwidth.
